(19) United States
(12) Patent Application Publication
(10) Pub. No.: US 2013/0035776 A1
(43) Pub. Date: Feb. 7, 2013

(54) Machine tool with audio feedback

(71) Applicant: Robert M. Kunstadt, New York, NY (US)

(72) Inventor: Robert M. Kunstadt, New York, NY (US)

(21) Appl. No.: 13/136,381

(22) Filed: Aug. 1, 2011

(51) Int. Cl. G05B 19/406

(52) U.S. Cl. 700/94

(57) ABSTRACT

A microphone senses the sound generated by a tool cutting a workpiece. The sound is analysed and compared to prior known sounds of good and bad cutting operations by an audio-processing device, and computer-controlled feedback is provided to control the tool and/or workpiece appropriately. The system can improve the quality of its feedback as a result of experience with particular tools and workpieces.

### FIELD OF THE INVENTION

This invention relates to the field of machinery for cutting of workpieces, such as milling machines, drills and lathes.

### SUMMARY OF THE INVENTION

In the present invention, a microphone senses the sound generated by a tool cutting a workpiece. The sound is analysed and compared to prior known sounds of good and bad cutting operations by an audio-processing device, and computer-controlled feedback is provided to control the tool and/or workpiece appropriately. The system can improve the quality of its feedback as a result of experience with particular tools and workpieces.

### DESCRIPTION OF THE DRAWINGS

FIG. 1 is a flowchart of the operation of the invention in one embodiment.

FIG. 2 is a flowchart of the operation of the invention in an alternate embodiment.

### DETAILED DESCRIPTION OF THE INVENTION

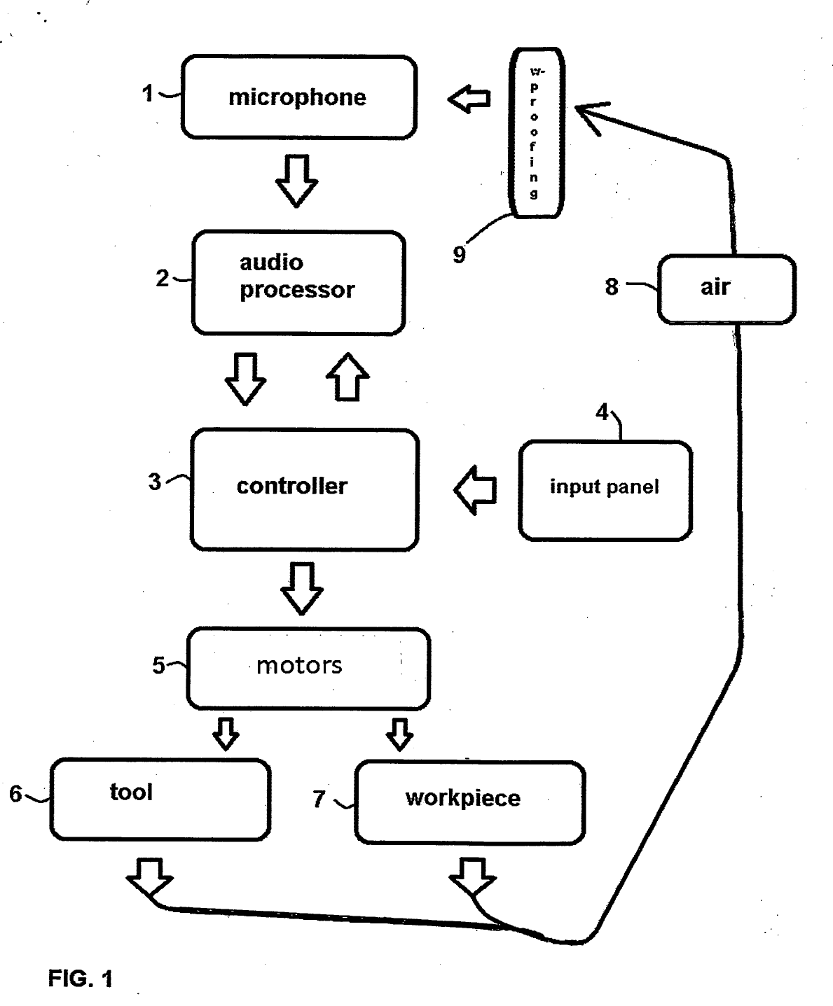

Referring now to FIG. 1, the invention will be described in detail.

When a human operator runs a milling machine or other such machine tool, the operator gains valuable information about the cutting operation by listening to the sound made.

If an operator hears chatter of the tool on the workpiece, the operator has to adjust the feed rate into the workpiece, or the RPM speed of the tool, either higher or lower to stop it.

When the tool is cutting at just the right feed and speed, the cutting action is smooth, the surface finish is fine not rough, the tool “hums along” through the workpiece, The tool lasts a longer time and does not so easily break, and the job gets done in good time.

Hence, shops usually want to run jobs on many parts, since once they have “dialed in” the right feed and speed, the job goes efficiently. But to determine those optimum settings takes trial and error work on the part of the operator—and it costs money for the customer.

As a solution according to the invention, one may install microphone 1 in the region of cutting tool 6. Microphone 1 may be waterproofed against water and oil, by a plastic or rubber waterproofing membrane 9 that does not unduly impede sound transmission.

Microphone 1 may be a SHURE SM57 dynamic cardioid microphone. It may be arranged in such manner as to follow the motion of tool 6 and/or to maintain a constant proximity thereto, resulting in a relatively uniform audio-signal level. The signal from microphone 1 may be recorded digitally within audio processor 2 and compared (in real time or near real time) to pre-recorded and/or pre-programmed signal patterns and signal features of tools and workpieces similar to those being employed; and designated incorrect cutting examples. In case of a match to correct cutting, audio processor 2 allows cutting to proceed under direction of controller 3. But in case incorrect cutting is detected, audio processor 2 directs controller 3 to alter feed and/or speed, say by 5% upwards. The process is repeated iteratively as needed, including alteration downwards, until a match to good cutting is achieved. Fine-tuning may also be employed, even in the absence of detected grossly-incorrect cutting, in order to optimize processing time for workpiece 7; and/or to obtain the best possible match to the pre-programmed and/or pre-recorded indicia of correct cutting.

Microphone 1 may alternatively be a RODE SVM stereo microphone (or the like) having an X-Y pattern, with one channel detecting mainly the sound from the cutting region and the other channel detecting mainly the background sound; whereupon the two channels may be processed with noise-cancellation techniques, for example subtraction, the better to isolate the signal of interest.

In accordance with an embodiment of the invention one may record the sound of correct and incorrect cutting operations. Provide audio processor 2 (including an audio recording memory and a computer program to use feature and/or pattern recognition techniques) to identify the difference, especially the transitions between correct cutting and incorrect cutting. Provide feedback from audio processor 2 to controller 3 that directs the feed and speed of tool 6 with respect to workpiece 7, via motors 5.

Hence, as tool 6 varies from correct to incorrect cutting of workpiece 7, and vice versa, audio processor 2 identifies the problem and undertakes corrective action via controller 3 and motors 5—without requiring human intervention. The operator can be doing other work, but the part is cut correctly.

Audio processor 2 may also monitor other parameters such as variance between actual feed rate and programmed rate; variance between actual RPM speed and programmed speed; torque of the spindle; physical vibration of the tool, part and worktable; and the like. Parameters such as the particulars of the tool and workpiece being used (e.g., diameter, length, flutes, material, alloy, coating and the like) may be entered via input panel 4, including in the conventional manner by use of G-Code. Input panel 4 may communicate this data to controller 3, which in turn may pass it to audio processor 2 (since controller 3 may be in two-way communication with audio processor 2). Supplemental pre-recordings of good and bad cutting may also be input to audio processor 2, in a similar manner, to update it.

One way to analyze audio is with an electronic tuner, of the type which identifies the fundamental pitch of a note played on a musical instrument.

More sophisticated harmonic analysis of audio signals can be undertaken by Fourier analysis. Different frequencies of sound can be separated out from the common underlying complex waveform.

Hence, according to the invention by running a new part one time, audio processor 2 may try different feeds and speeds and may learn when and where in the G-Code's run-time problems have occurred—by “listening” for them—and will plan preventive adjustments so that it will not happen again on making another similar part.

Audio processor 2 may also over time learn which tools (type of tool and/or individual tool) and/or workpiece materials (and/or particular workpieces for particular jobs) need which feeds and speeds as they are asked to make each individual type and size of cut, so that even the incidence of mistakes made in the first place will be reduced—in that feeds and speeds that have caused bad results may be avoided but feeds and speeds that have caused good results may be preferred.

Audio processor 2 may also use its learning to implement immediate corrective action on the very first sound of trouble while cutting a part, by detecting the start of any deviation from the proper “humming” sound of good cutting action and adjusting the feed and speed accordingly; or if necessary shutting the machine off and summoning human-operator intervention by an alert signal.

Various techniques may be employed in the operation of audio processor 2 for identifying, comparing and recognizing detected and recorded sounds. Reference may be made to U.S. Pat. No. 5,842,161 concerning processing and recognition of human speech, as an example of such techniques. Further examples may be seen in U.S. Pat. No. 6,038,342 relating to optical character recognition (OCR); U.S. Pat. No. 7,085,411 relating to optical inspection of electronic components; and U.S. Pat. No. 5,245,665 relating to identification and filtering to suppress spurious audio “howling” due to unwanted acoustic feedback in a public address system. The scientific discipline of pattern and feature recognition by automated-computerized means provides teachings for mathematically and/or algorithmically comparing a pattern to a pre-existing pattern, and for detecting and analyzing features of a signal and for distinguishing between signal and noise. The recognition that such scientific knowledge can appropriately be employed in the field of the invention by analyzing the sound produced by a running tool while shaping a workpiece, said sound being airborne, contributes to the novel and inventive teaching of this disclosure.

The disclosures of the aforementioned prior art patents are incorporated herein by reference.

An online research paper by SAAB discussed using motion sensors to measure physical vibration of a tool. While the paper usefully explains the math of analysing tool vibrations, it does not teach or disclose that microphones could be employed and the airborne sound analyzed while cutting, to improve the quality of the control feedback in real time (or near real time). The aforementioned research paper teaches the use of at least one sensor mounted on a tool holder, together with dedicated supplemental activators responsive to such sensor for correcting tool deflection. Such supplemental activators are not required in connection with the present invention (although they may be employed). Dedicated supplemental activators increase cost. A sensor mounted on a tool holder may be impractical while the tool turns at high speed as in a milling machine.

The airborne sound impinging on microphone 1 is directly related not only to vibration of tool 6, but to the interaction of tool 6 and workpiece 7, which is exactly “where the rubber meets the road”, as a TV commercial for Firestone car tires used to say. Tool 6 may be vibrating but not causing any substantial problem, if it vibrates in a “good” way: the “humming” sound. But when it goes bad, you hear it immediately as a marked deviation from the “humming” sound.

A machine tool such as a milling machine may include a chuck for holding a tool; and a bed for permitting a workpiece to move in various axes (X, Y, etc.).

There would ordinarily be some baseline “good vibration” as part of a metal-cutting process, because it is a stick/slip process as teeth engage the workpiece. It is similar to how a violin bow engages a violin string with stick/slip to produce a musical tone, which has been documented by the physicist von Hemholtz.

The sound of a violin can be very good or very bad, even though in both cases there is vibration of the string taking place. The amplitude of vibration is not the sole distinguishing criterion. The trained violinist has to know the difference between a good sound and a bad sound, and how to produce the good one. What is disclosed here, is to treat tool 6 and its associated workpiece 7 like a musical instrument and to employ an audio-feedback-based, self-learning automated control apparatus to recognize the good and bad sounds they can make; and to control tool 6 and/or workpiece 7 accordingly.

Visual feedback is not especially practical in this context, since when metal (or wood or plastic) is cut it fragments into many small chips that obscure the workpiece. Also, tool 6 and workpiece 7 often are flooded with cutting fluid so hardly anything is visible but the fluid. Hence, audio feedback as disclosed herein, represents a useful advance in this application.

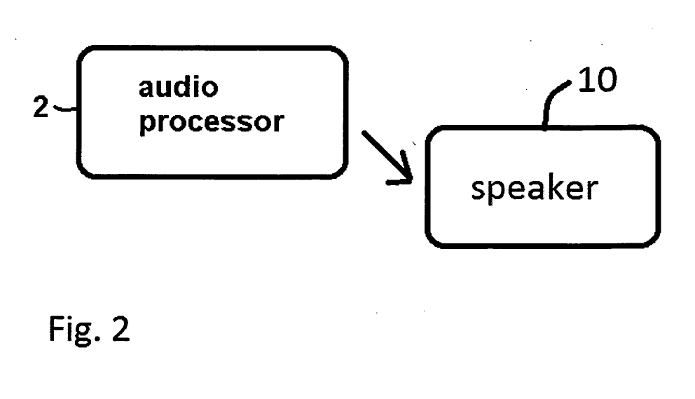

Referring to FIG. 2, an embodiment of the invention may be provided with speaker 10 driven by audio processor 2, so that an operator may hear sounds recorded by audio processor 2. The recording and playback of such sounds may be synchronized with the G-Code (or other such machine code) that controls cutting operations, so as to permit a display incorporated on input panel 4 to show the cutting operation being undertaken at the time that a particular sound was recorded. This will facilitate debugging of any problems encountered, as well as optimization of the cutting operation.

The invention is not limited to the exact embodiments shown and described, and may be realized in such other ways as will be apparent to the skilled artisan, utilizing the teachings of the invention.

1. A machine tool comprising a controller, a microphone and an audio processor.

2. A machine tool according to claim 1; said machine tool being adapted to modify machining parameters in response to airborne sound impinging on said microphone.

3. A machine tool according to claim 2, said machine tool having a chuck and a bed; said microphone being positioned to detect sound waves transmitted through the air from the region of said chuck and said bed.

4. A machine tool according to claim 3, said microphone being provided with waterproofing.

5. A machine tool according to claim 3, said audio processor being provided with at least one pre-recorded sample of the sound of at least one machining operation.

6. A machine tool according to claim 5, said audio processor being adapted to analyze said sound waves detected by said microphone and to compare said sound waves to said at least one pre-recorded sample.

7. A machine tool according to claim 5, said audio processor being a self-learning processor.

8. A machine tool according to claim 1, said machine tool further comprising a speaker.

9. A machine tool according to claim 8, said audio processor being adapted to record audio signals through said microphone and to playback said audio signals through said speaker, said recording and playback being time-synchronized with a visual display of machine-tool programming code.

10. A machine tool according to claim 9, said microphone being a stereo microphone provided with a first axis and a second axis, said first axis being positioned to detect the sound of cutting and said second axis being positioned to detect background sounds; and said audio processor providing noise-cancellation.
